(19) United States
(12) Patent Application Publication
(10) Pub. No.: US 2018/0194368 A1
(43) Pub. Date: Jul. 12, 2018

(54) METHOD AND CONTROL DEVICE FOR CONTROLLING AN ACTIVE ACCELERATOR

(71) Applicant: AUDI AG, Ingolstadt (DE)

(72) Inventors: Daniel LEPCZYK, Schrobenhausen (DE); Maximilian DIETRICH, München (DE); Daria MAKHORTOVA, Ingolstadt (DE)

(73) Assignee: AUDI AG, Ingolstadt (DE)

(21) Appl. No.: 15/742,193

(22) PCT Filed: Jul. 9, 2016
(86) PCT No.: PCT/EP2016/001184

§ 371 Date: Jan. 5, 2018

(30) Foreign Application Priority Data
Aug. 1, 2015 (DE) 10 2015 010 047.5

(51) Int. Cl. B60W 50/16; G05G 1/44; G05G 5/03; B60K 26/02

(52) U.S. Cl. CPC B60W 50/16; G05G 1/44; G05G 5/03; B60W 50/082; B60K 2026/023; B60W 2510/244; B60K 26/021

(57) ABSTRACT

A method for controlling a device, in which a control command for controlling the device is produced via a force controller that is actuated by a user. A control unit of the device controls at least one actuator in such a way that the at least one actuator provides the user, at a predetermined path point of the force controller, with a feedback message about at least one state of the device at the force controller. The control unit further controls the at least one actuator in such a way that, in case of a change in the predetermined path point of the force controller to a changed path point lying in the direction of deflection of the force controller in front of the predetermined path point, the at least one actuator shifts the force controller to a desired path point.

The present invention relates to a method for controlling a device as well as a control device and a vehicle.

During operation of devices, such as, for example, of vehicles with a plurality of states, that is, operating states, a respective user can be given a change in a current operating state of the device by means of a feedback message, such as, for example, a changed pressure point at a force controller, such as, for example, a pedal. Thus, in the case of hybrid vehicles with a plurality of drive assemblies, for example, it can be appropriate to provide the respective user with a feedback message about a switching on of an internal combustion assembly to an electric drive in order to inform the user about the switching on of the internal combustion assembly.

In the German published unexamined patent DE 10 2014 051 29 A1, a method is disclosed for providing a feedback message of a changed operating state of a vehicle to a driver.

A method for indicating a change of a traveling drive is disclosed in the German published unexamined patent DE 10 2012 108 589 A1.

The document DE 11 2009 002 530 T5 discloses the provision of a warning to a driver of a vehicle for the case when the vehicle has reached a limit state.

Against this background, a method for controlling a device is presented, for which a control command for controlling the device is produced via a force controller that is actuated by a user, wherein a control unit of the device controls at least one actuator in such a way that, at a predetermined path point of the force controller, the at least one actuator provides the user with a feedback message about at least one state of the device at the force controller, and wherein the control unit further controls the at least one actuator in such a way that, for a change in the predetermined path point of the force controller to a changed path point lying in a direction of deflection of the force controller in front of the predetermined path point, the at least one actuator shifts the force controller to a desired path point, which lies in the direction of deflection of the force controller in front of the changed path point, so that, for a shift of the force controller in the direction of deflection, the user is provided with the feedback message about the at least one state at the changed path point when the force controller reaches the changed path point on its path in the direction of deflection.

The presented method serves, in particular, for providing a feedback message of a changed state, that is, an operating state, of a vehicle to a driver. It is hereby provided that, for the case when the feedback message is to be provided at a path point of a force controller—such as, for example, an accelerator pedal of the vehicle—that has already been exceeded or passed by the force controller owing to input of the driver, the force controller, if appropriate together with the foot of the driver, is shifted in back of the path point for providing the feedback message, so that the feedback message can be provided to the driver with the force controller when the path point has been passed once again.

In particular, it is provided that the force controller, together with the foot of the driver or user, is shifted in such a way that the driver or user is not aware of a shifting operation of the force controller.

Obviously, the presented method is suitable for any kind of user interfaces that control a plurality of states of a device. Accordingly, a force controller is to be understood in the context of the present invention to mean any device for adjustment of a force at a device, in particular, a pedal, such as, for example, an accelerator pedal.

Because a feedback message that is to be transmitted to a user of a device generally arises during an operation of the device, it can transpire that, for control of the device, a force controller has already been brought by the user into a position that lies in back of a path point at which the feedback message to be transmitted is to be provided. In order to transmit the feedback message to the user nonetheless or to put the user in a position where the feedback message can occur, if need be, it is provided in accordance with the invention that the force controller is traveled by an actuator, such as, for example, a linear solenoid or any other technically suitable device for shifting a force controller, from a current path point to a changed path point, that is, a desired path point, which lies in front of the path point at which the feedback message is to be provided.

This means that the force controller is shifted along its track of movement for controlling the device from a first point A to a second point B, wherein the second point B lies in front of the point A and in front of a point at which the feedback message is to be provided. Accordingly, it is provided that, during the shift from point A to point B by means of the actuator, the force controller passes the point at which the feedback message is to be provided opposite to a direction that is provided for the feedback message, so that is becomes possible for the user to move the force controller beyond the point at which the feedback message is provided in the direction provided for the feedback message.

In a clarifying example, a driver of a hybrid vehicle, which has an electric drive and an internal combustion engine, controls the hybrid vehicle by using an accelerator pedal. A control unit of the hybrid vehicle is configured for the purpose of providing the driver with a feedback message in the form of a pressure point, which is mediated by an actuator, when the accelerator pedal passes over a first path point along a track of movement of the accelerator pedal, said first path point leading to a switching on of the internal combustion engine. If a state of charge of a battery of the hybrid vehicle then drops below a predetermined value, it is provided that the internal combustion engine is switched on even earlier, that is, at a lower power requirement or at a smaller pedal angle. In order to afford the driver nonetheless the possibility of operating the hybrid vehicle in a purely electric manner, the driver must be given the possibility of moving the accelerator pedal into angular positions that lie in front of a path point that brings about the switching on of the internal combustion engine. For this purpose, it is provided that, in the case when the driver briefly holds or fixes in place the accelerator pedal in an initial situation, and the path point for the switching on of the internal combustion engine is shifted in response to the discharging of the battery, the accelerator pedal, if appropriate together with the foot of the driver, is shifted or deflected in front of a new or shifted path point. Through the shifting of the accelerator pedal, the driver is put in the position of deciding on a switching on of the internal combustion engine to be undertaken, if need be, even in the case of a changed path point. If the path point for the switching on of the internal combustion engine were displaced, without the accelerator pedal being correspondingly shifted, the internal combustion engine would be switched on without any command of the driver or without any feedback message being transmitted beforehand to the driver, because the position of the path point for switching on the internal combustion engine or of a path point for a corresponding feedback message to the driver would have been shifted on the track of movement of the accelerator pedal virtually “all the way under the foot of the driver”.

In one possible embodiment of the presented method, it is provided that the at least one state is chosen from one or a combination of states taken from the following list of states: critical power query, switching on of a drive assembly, or exceeding of a predetermined speed, as well as any other state during the operation of a device that is to be controlled by means of a force controller.

In yet another possible embodiment of the presented method, it is provided that a function for providing the feedback message to the user at the changed path point is activated only after the force controller has been shifted to the desired point.

In order to provide the feedback message already when the changed path point is passed during a return movement, that is, in order to prevent a shifting movement of the force controller mediated by the actuator, it is provided in one embodiment that a function for providing the feedback message to the user is activated only when the force controller has arrived at the desired path point, that is, at a respective changed point and in front of the point for providing the feedback message with respect to the changed operating state.

In another possible embodiment of the presented method, it is provided that the force controller is shifted to the desired path point by means of a movement function, which actuates the at least one actuator in such a way that the movement of the force controller to the desired path point is not noticed by the user.

In order to enable a particular user of a particular device to operate the device intuitively, it is provided that the presented method, that is, in particular, the shifting of the force controller onto the desired path point, proceeds in such a way that the user is not aware of corresponding displacement operations and accordingly obtains solely a feedback message about a possibly changing or changed state of the device at a predetermined path point on a track of movement of a respective force controller.

In order to allow respective displacement operations of the force controller or of a respective actuator to occur unnoticed by the user, it is conceivable that the displacement operations proceed by means of a movement function that is optimized in regard to perception by the user.

In a possible embodiment of the presented method, it is provided that the movement function is a ramp function.

A possible embodiment of a movement function, which is optimized in regard to perception by a user, is a ramp function for which a respective actuator is actuated for shifting of the force controller along its track of movement initially with a low current, so that the actuator produces a correspondingly small force, which is not noticed by the user. Through continuous increase of the current or of the force produced by the actuator, the actuator attains, at a specific point, precisely the force with which the user acts on the force controller and neutralizes the force applied by the user with a corresponding counteracting force. If the force applied by the actuator at this point is then further increased slowly or in small steps, the force controller, together with the foot of the user, travels gently and unnoticeably to the desired path point. Once the pedal arrives at the desired path point, the force applied by the actuator or the corresponding current is reduced and the user can use the force controller at the desired path point as accustomed. For neutralization of the force applied by the user, the actuator can be slowly supplied with increasing current and/or a force sensor, which predetermines a force to be applied by the actuator, can be employed at the force controller.

In another possible embodiment of the presented method, it is provided that the movement function actuates the actuator in such a way that the force controller is shifted in stages to the desired path point.

It is also conceivable that the actuator is actuated in stages for shifting of the force controller, so that, for example, depending on a specific event, such as, for example, a change of the force applied by the user on the force controller, a plurality of small and rapid movements of the force controller can be made in order to shift the force controller to the desired path point.

In another possible embodiment of the presented method, it is provided that the feedback message to the user is chosen from of the following list of feedback messages: vibrational patterns, changed pressure point, or changed pressure resistance.

The present invention further relates to a control device for a device, with a force controller, a control unit, and at least one actuator, wherein the control unit is configured for the purpose of providing the user, at a predetermined path point of the force controller, with a feedback message about at least one state of the device at the force controller by means of the at least one actuator, and wherein the control unit is further configured for the purpose of actuating the at least one actuator in such a way that, for a change in the predetermined path point to a changed path point lying in the deflection direction of the force controller in front of the predetermined path point, the force controller is to be shifted to a desired path point by means of the at least one actuator, said desired path point lying in the direction of deflection of the force controller in front of the changed path point, so that, for a shift of the force controller in the direction of deflection, the user is provided at the changed path point with the feedback message about the at least one state for the case when the force controller reaches the changed path point on its path in the direction of deflection.

The presented control device serves, in particular, for implementation of the presented method.

In a possible embodiment of the presented control device, it is provided that the device is a device taken from the following list of devices: vehicle, aircraft, watercraft, transport means, and tool, as well as any other technical device having a plurality of operating states.

The present invention further relates to a vehicle with an embodiment of the presented control device for implementation of the presented method.

It is provided, in particular, that the presented vehicle is a hybrid vehicle, for which the feedback message provided in accordance with the invention is a feedback message about a switching on of an internal combustion engine to an electric drive.

Additional advantages and embodiments of the invention ensue from the description and the appended drawings.

It is understood that the aforementioned features and the features still to be explained below can be used not only in the particular given combination, but also in other combinations or alone without departing from the scope of the present invention.

The invention is illustrated schematically in the drawings on the basis of one embodiment and is described schematically and in detail with reference to the drawings.

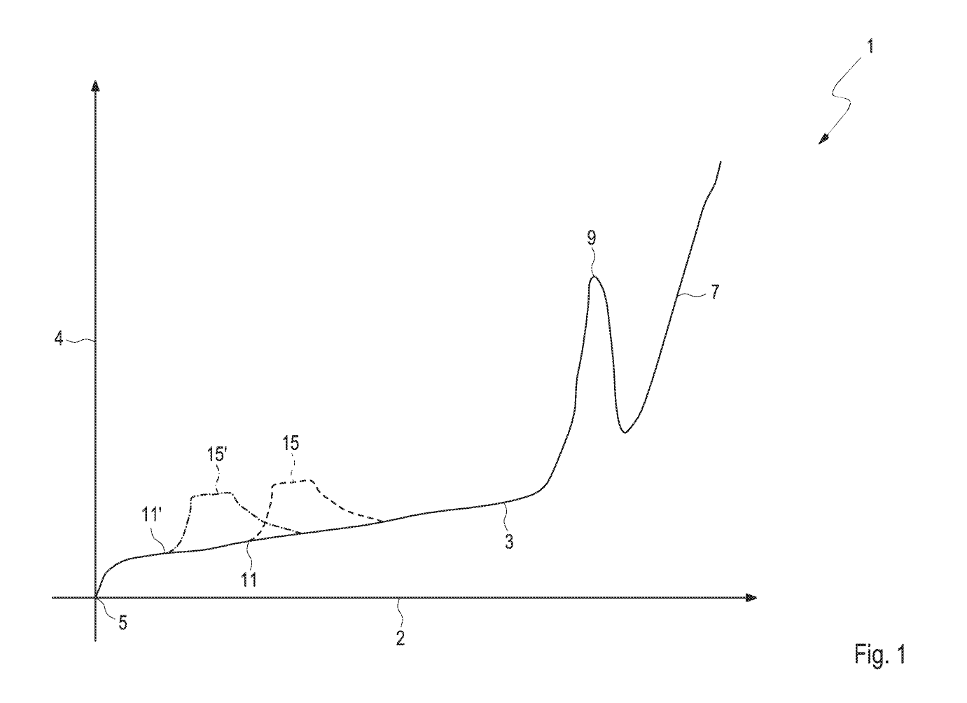

FIG. 1 shows a schematic illustration of a shifting of a force controller from a predetermined path point to a desired path point in accordance with a possible embodiment of the presented method.

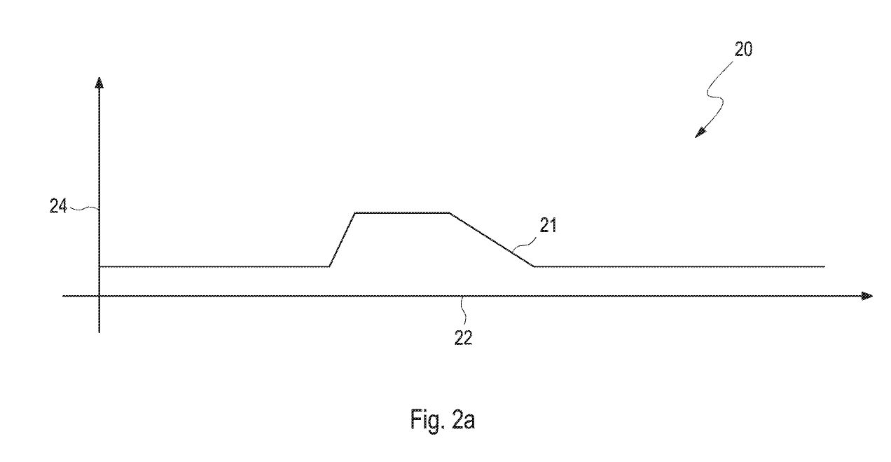

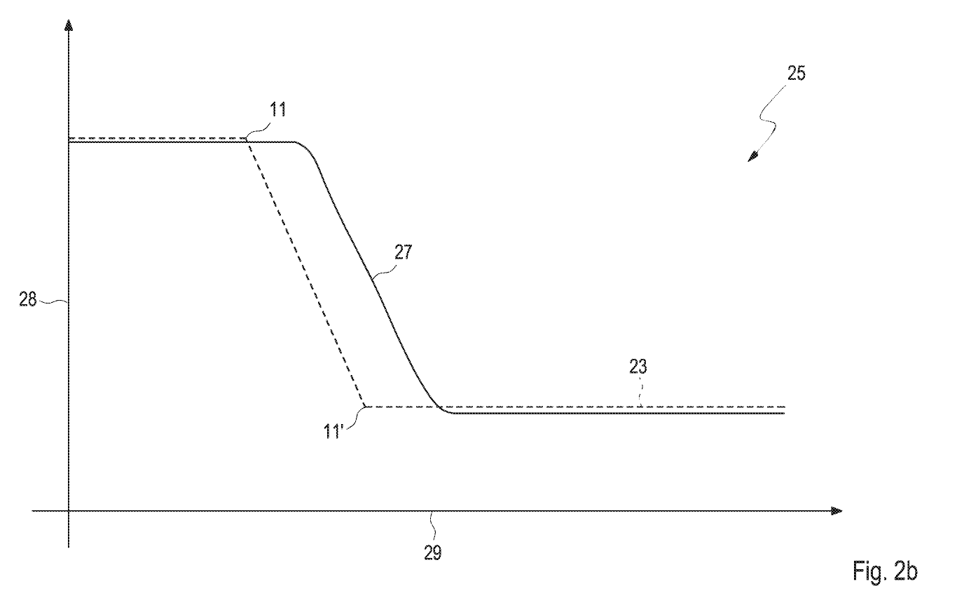

FIG. 2a shows a curve of a force applied by an actuator for shifting a force controller in accordance with a possible embodiment of the presented method.

FIG. 2b shows a movement curve of a force controller as well as of a foot of a user arranged on the force controller while the actuator acts on the force controller with a force in accordance with FIG. 2a.

Illustrated in FIG. 1 is a diagram 1 in which, on the abscissa 2, a path is plotted in [cm] and, on the ordinate, 4 a force axis is plotted in [N] . A curve 3 shows a force expenditure that a driver has to impose during a movement of an accelerator pedal of a vehicle along a track of movement, which leads from a rest position 5 to a full-load or kickdown position 7, in which a final gear stage is engaged. The reaching of the full-load position is fed back to the driver via a kickdown point 9.

In order to give the driver a feedback message about an operating state of the vehicle at which an internal combustion engine of the vehicle is to be switched on additionally to an electric drive, it is provided that an actuator counteracts the accelerator pedal on its path along the curve 3, at or just in front of a path point 11, with a force that defines a pressure point, such as is indicated by a curve 15. The force applied by the actuator brings about a pressure that counteracts a force applied by the driver for shifting the accelerator pedal along the curve 3, so that the driver is aware of the path point 11 and can decide whether to pass said point with the accelerator pedal and to switch on the internal combustion engine or whether to move the accelerator pedal solely up to the pressure point at or just in front of the path point 11 and to drive solely by means of the electric drive.

During operation of the vehicle, it can transpire that, for example, a state of charge of a battery of the vehicle changes in such a way that the internal combustion engine must be switched on already for an operating state of the vehicle for which a power requirement is called upon that corresponds to a position of the accelerator pedal that lies in front of the path point 11 at, for example, a changed path point 11′. Accordingly, it is necessary that the point at which the driver is provided by means of the actuator with the pressure point for providing a feedback message about the switching on of the internal combustion engine also changes or that the pressure point is shifted, as indicated by a shifted curve 15′. Otherwise, the switching on of the internal combustion engine would no longer coincide with the provided pressure point and the driver would have no control over the switching on of the internal combustion engine.

For example, for the case when the driver holds the accelerator pedal just in front of the path point 11 in order to prevent any switching on of the internal combustion engine and when the operating state of the vehicle requires a shift of the pressure point from the path point 11 to the changed path point 11′, the pressure point or the path point for activation of the internal combustion engine would have shifted “all the way under the foot” of the driver and the internal combustion engine would have been switched on without the will of the driver. In order to prevent such a scenario, it is provided in accordance with the invention that, during a shift of the pressure point, the accelerator pedal is also shifted, so that the pressure point for the feedback message to the driver about the switching on of the internal combustion engine lies on or just in front of the changed path point 11′.

Illustrated in FIG. 2a in a diagram 20 is a force curve 21 of an actuator for shifting the accelerator pedal from the path point 11 to the path point 11′ in accordance with FIG. 1, in which, in the axes, the force in [N] is plotted on the ordinate 24 and the time in [s] is plotted on the abscissa 22. In FIG. 2b, a movement curve of the accelerator pedal from the path point 11 to the path point 11′ is illustrated as a function of the force curve plotted in FIG. 2a.

For shifting of the accelerator pedal from the path point 11 to the path point 11′, an actuator, such as, for example, a linear solenoid, is supplied with current until the accelerator pedal has shifted from the path point 11 to the path point 11′. It is hereby provided that the actuator is supplied with current in accordance with a movement function, which brings it about that the driver does not notice the shifting operation of the accelerator pedal. The force curve 21, illustrated in FIG. 2a, shows how the force applied by the actuator is slowly increased until it just exceeds a force applied by the user for holding the accelerator pedal at its current position, so that the accelerator pedal is moved beyond the path point 11. Once the accelerator pedal is in movement, the force level of the actuator remains constant until the accelerator pedal has arrived at the changed path point 11, in accordance with the curve 23 illustrated in FIG. 2b′.

Illustrated in FIG. 2b is a diagram 25 in which, on the ordinate 28, a path is plotted in [cm] and, on the abscissa 29, a time axis is plotted in [s]. A foot of the device resting on the accelerator pedal is accordingly shifted along with the accelerator pedal, as indicated by a curve 27. This means that also the foot of the driver is shifted from the path point 11 to the path point 11′ and the driver is afforded the possibility of approaching the changed pressure point with the accelerator pedal.

1-14. (canceled)

15. A method for controlling a device, comprising:
a control command for controlling the device is produced via a force controller that is actuated by the user, wherein a control unit of the device controls at least one actuator in such a way that, at a predetermined path point of the force controller, the at least one actuator provides the user, at the force controller, with a feedback message about at least one state of the device, and wherein the control unit further controls the at least one actuator in such a way that, in case of a change in the predetermined path point of the force controller to a changed path point lying in the direction of deflection of the force controller in front of the predetermined path point, the at least one actuator shifts the force controller to a desired path point, which lies in the direction of deflection of the force controller in front of the changed path point, so that, for a shift of the force controller in the direction of deflection, the user is provided at the changed path point with the feedback message about the at least one state when the force controller reaches the changed path point on its path in the direction of deflection.

16. The method according to claim 15, wherein the force controller is shifted together with a foot of the user during the shift to the desired path point.

17. The method according to claim 15, wherein the at least one state is chosen from one or a combination of the following list of states: critical power query, switching on of a drive assembly, or exceeding of a predetermined speed.

18. The method according to claim 15, wherein a function for providing the feedback message to the user at the changed path point is activated only after the force controller has been shifted to the desired point.

19. The method according to claim 15, wherein the force controller is shifted to the desired path point by a movement function, which actuates the at least one actuator in such a way that the movement of the force controller to the desired path point is not noticed by the user.

20. The method according to claim 19, wherein the movement function is a ramp function.

21. The method according to claim 19, wherein the movement function actuates the actuator in such a way that the force controller is shifted in stages to the desired path point.

22. The method according to claim 15, wherein the feedback message to the user is chosen from the following list of feedback messages: vibrational pattern, changed pressure point, or changed pressure resistance.

23. A control device for a device, comprising:
a force controller, a control unit, and at least one actuator, wherein the control unit is configured for the purpose of providing the user, at a predetermined path point of the force controller, with a feedback message about at least one state of the device at the force controller by the at least one actuator, and wherein the control unit is further configured for the purpose of actuating the at least one actuator, in such a way that, in case of a change in the predetermined path point to a changed path point lying in the direction of deflection of the force controller in front of the predetermined path point, the force controller is shifted to a desired path point by the at least one actuator, said desired path point lying in the direction of deflection of the force controller in front of the changed path point, so that, for a shift of the force controller in the direction of deflection, the user is provided, at the changed path point, with the feedback message about the at least one state for the case when the force controller has reached the changed path point on its path in the direction of deflection.

24. The control device according to claim 23, wherein the at least one actuator is a linear solenoid.

25. The control device according to claim 23, wherein the device is a device taken from the following list of devices: vehicle, aircraft, watercraft, transport means, and tool, as well as any other technical device having a plurality of operating states.

26. The control device according to claim 23, wherein the force controller is a pedal.
